(19) United States
(12) Patent Application Publication
(10) Pub. No.: US 2026/0031874 A1
(43) Pub. Date: Jan. 29, 2026

(54) COMMUNICATION METHOD AND APPARATUS, DEVICE, STORAGE MEDIUM, AND CHIP

(71) Applicant: Beijing Xiaomi Mobile Software Co., Ltd., Beijing (CN)

(72) Inventor: Min LIU, Beijing (CN)

(21) Appl. No.: 18/998,010

(22) PCT Filed: Aug. 4, 2022
(86) PCT No.: PCT/CN2022/110374

§ 371 Date: Jan. 23, 2025

(51) Int. Cl. H04B 7/06; H04W 72/0453

(52) U.S. Cl. CPC H04B 7/0626; H04W 72/0453

(57) ABSTRACT

A communication method is performed by a terminal device and includes: receiving first configuration information from a network device, wherein the first configuration information is configured to indicate a correspondence between input information of a channel state information (CSI) compression encoding model and CSI reporting information.

### CROSS REFERENCE TO RELATED APPLICATIONS

This application is a US National Phase of International Application No. PCT/CN2022/110374, filed on Aug. 4, 2022, the entire content of which is incorporated herein by reference.

### TECHNICAL FIELD

The present disclosure relates to the field of communication technologies and in particular to communication methods and apparatuses, devices, a storage medium, and a chip.

### BACKGROUND

Channel state information (CSI) reporting refers to that a terminal device obtains CSI based on measurement on a downlink reference signal (e.g. channel state information reference signal, (CSI-RS)) transmitted by a network device and reports the CSI to the network device based on a reporting mode and a reporting resource configured by the network device.

In the related arts, artificial intelligence (AI)/machine learning (ML) models are introduced into CSI reporting scenarios. For example, a terminal device may obtain CSI based on measurement on downlink reference signal and perform compression encoding on the CSI by a CSI compression encoding model to obtain compression-encoded CSI and then quantize the compression-encoded CSI into a binary bit stream and transmit it to a network device; the network device may de-quantize the above received binary bit stream and input information obtained by de-quantization into a CSI decoding model for decoding to obtain recovered CSI. The above CSI compression encoding and CSI decoding models may be AI/ML model.

At present, the CSI reporting scenarios with introduction of AI/ML model remain to be further researched.

### SUMMARY

According to an aspect of embodiments of the present disclosure, there is provided a communication method, which is performed by a terminal device. The method includes:
receiving first configuration information from a network device, wherein the first configuration information is configured to indicate a correspondence between input information of a channel state information (CSI) compression encoding model and CSI reporting information.

According to an aspect of embodiments of the present disclosure, there is provided a communication method, which is performed by a network device. The method includes:
transmitting first configuration information to a terminal device, wherein the first configuration information is configured to indicate a correspondence between input information of a channel state information (CSI) compression encoding model and CSI reporting information.

According to an aspect of embodiments of the present disclosure, there is provided a terminal device, which includes a processor and a memory. The memory stores computer programs, and the processor executes the computer programs to perform the communication method of the above terminal device side.

According to an aspect of embodiments of the present disclosure, there is provided a network device, which includes a processor and a memory. The memory stores computer programs, and the processor executes the computer programs to perform the communication method of the above network device side.

According to an aspect of embodiments of the present disclosure, there is provided a non-transitory computer readable storage medium, which stores computer programs. The computer programs are executed by a processor to perform the communication method of the above terminal device side or the communication method of the above network device side.

According to an aspect of embodiments of the present disclosure, there is provided a communication system, which includes a terminal device and a network device. The terminal device is configured to perform the communication method of the terminal device side, and the network device is configured to perform the communication method of the above network device side.

According to an aspect of embodiments of the present disclosure, there is provided a chip, which includes a programmable logic circuit and/or program instructions. The chip runs to perform the communication method of the above terminal device side or the communication method of the above network device side.

### BRIEF DESCRIPTION OF THE DRAWINGS

The accompanying drawings, which are incorporated in and constitute a part of the present description, illustrate examples consistent with the embodiments of the present disclosure and serve to explain the principles of the embodiments of the present disclosure together with the description.

FIG. 1 is a schematic diagram illustrating a network architecture according to an embodiment of the present disclosure.

FIG. 2 is a flowchart illustrating a communication method according to an embodiment of the present disclosure.

FIG. 3 is a flowchart illustrating a communication method according to another embodiment of the present disclosure.

FIG. 4 is a flowchart illustrating a communication method according to another embodiment of the present disclosure.

FIG. 5 is a block diagram illustrating a communication apparatus according to an embodiment of the present disclosure.

FIG. 6 is a block diagram illustrating a communication apparatus according to another embodiment of the present disclosure.

FIG. 7 is a block diagram illustrating a communication device according to an embodiment of the present disclosure.

### DETAILED DESCRIPTION OF THE EMBODIMENTS

Embodiments will be described in details herein, with the illustrations thereof represented in the drawings. When the following descriptions involve the drawings, like numerals in different drawings refer to like or similar elements unless otherwise indicated. The embodiments described in the following examples do not represent all embodiments consistent with the present disclosure. Rather, they are merely examples of apparatuses and methods consistent with some aspects of the present disclosure as detailed in the appended claims.

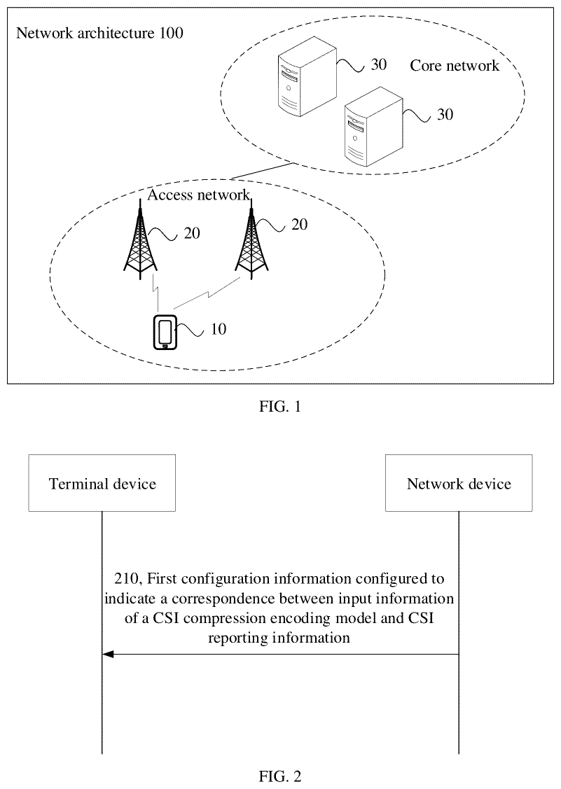

FIG. 1 is a schematic diagram illustrating a network architecture 100 according to an embodiment of the present disclosure. The network architecture 100 may include a terminal device 10, an access network device 20 and a core network device 30.

The terminal device 10 may be a user equipment, an access terminal, a user unit, a user station, a mobile station, a mobile, a remote station, a remote terminal, a mobile device, a wireless communication device, a user agency or a user apparatus or the like. Optionally, the terminal device 10 may also be a cell phone, a cordless telephone, a session initiation protocol (SIP) telephone, a wireless local loop (WLL) station, a personal digital assistant (PDA) device, a palm-held device or computing device having wireless communication function, or another processing device connected to wireless modem, a vehicle-mounted device, a wearable device, a terminal device in 5th Generation System or a terminal device in a future evolved Public land mobile network (PLMN) or the like, which is not limited in the embodiments of the present disclosure. For ease of descriptions, the devices mentioned above are collectively called terminal device. There may usually be multiple terminal devices 10 and one or more terminal devices 10 may be distributed in a cell under the management of each access network device 20. In the embodiments of the present disclosure, “terminal device” and “UE” are usually mixed for use but persons skilled in the arts can understand both of them usually indicate a same meaning.

The access network device 20 is a device deployed in an access network to provide wireless communication function for the terminal device 10. The access network device 20 may include various types of macro base stations, micro base stations, relay stations or access points or the like. In systems adopting different wireless access technologies, the devices having the function of access network device may have different names, for example, in the 5G NR system, it is called gNodeB or gNB. Along with the evolution of the communication technology, the name “access network device” may change. For ease of descriptions, in the embodiments of the present disclosure, the apparatuses providing wireless communication function for the terminal device 10 are collectively called access network device. Optionally, the terminal device 10 establishes a communication relationship with the core network device 30 via the access network device 20. Illustratively, in the long term evolution (LTE) system, the access network device 20 may be evolved universal terrestrial radio access network (EUTRAN) or one or more eNodeBs in the EUTRAN; in the 5G NR system, the access network device 20 may be Radio Access Network (RAN) or one or more gNBs in the RAN. In the embodiments of the present disclosure, the “network device” refers to the access network device 20, for example, a base station, unless otherwise stated.

The core network device 30 is a device deployed in the core network and the main function of the core network device 30 provides user connection, performs user management and completes service bearing to provide an interface to an external network as a bearer network. For example, the core network device in the 5G NR system may include an access and mobility management function (AMF) entity, a user plane function (UPF) entity and a session management function (SMF) entity and the like.

In some embodiments, mutual communication between the access network device 20 and the core network device 30 is carried out by an air interface technology, for example, by NG interface in the 5G NR system. Mutual communication between the access network device 20 and the terminal device 10 is carried out by an air interface technology, for example, by Uu interface.

The “5G NR system” in the embodiments of the present disclosure can also be referred to as 5G system or NR system as long as those skilled in the arts can understand its meaning. The technical solutions described in the embodiments of the present disclosure can be applied to the LTE system, or to the 5G NR system or to a subsequent evolved system of the 5G NR system or to other communication systems such as narrow band internet of things (NB-IoT) system, which is not limited herein.

In the embodiments of the present disclosure, the network device may provide service for a cell and the terminal device may communicate with the network device via a transmission resource (e.g. frequency domain resource, or spectrum resource) on a carrier used by the cell. The cell may be a cell corresponding to the network device (e.g. base station), and the cell may belong to a macro base station or to a base station corresponding to a small cell. The small cell herein may include: a Metro cell, a Micro cell, a Pico cell and a Femto cell and the like. These cells have the characteristics of small coverage and low transmission power and can be applicable to providing high-rate data transmission services.

FIG. 2 is a flowchart illustrating a communication method according to an embodiment of the present disclosure. The embodiment is exemplified with the method being applied to the network architecture shown in FIG. 1. The method may include the following step 210.

At step 210, a terminal device receives first configuration information from a network device, where the first configuration information is configured to indicate a correspondence between input information of a channel state information (CSI) compression encoding model and CSI reporting information.

The network device transmits the first configuration information to the terminal device and accordingly the terminal device receives the first configuration information from the network device.

The CSI compression encoding model is an AI/ML model for performing compression encoding on CSI. The input information of the CSI compression encoding model refers to information input into the model, for example, the CSI obtained by the terminal device by performing measurement on a reference signal (also called pilot signal, e.g. CSI-RS) transmitted by the network device. The CSI reporting information of the CSI compression encoding model can be understood as output information of the CSI compression encoding model, namely, the information output by the model performing compression encoding on the above input information, or can be understood as information generated by performing reprocessing on the output information of the CSI compression encoding model, for example, quantized information or the like. The CSI reporting information may be understood as uplink control information (UCI), and channel coding, cyclic redundancy check (CRC), scrambling code and various coding and modulation processes required for specific transmissions are not within the scope of the present disclosure. The CSI reporting information is transmitted by the terminal device to the network device such that the network device can decode and recover the CSI based on the CSI reporting information. For example, the network device can decode the CSI reporting information by a CSI decoding model to obtain the recovered CSI.

In some embodiments, the first configuration information is carried in a radio resource control (RRC) signaling. For example, the network device transmits an RRC signaling carrying the above first configuration information to the terminal device.

In some embodiments, the first configuration information is configured to indicate a correspondence between at least one set of input information of the CSI compression encoding model and the CSI reporting information. Optionally, the first configuration information is configured to indicate a correspondence between multiple sets of different input information of the CSI compression encoding model and the CSI reporting information.

In some embodiments, the first configuration information may be one table or represented in the form of table. The table may include a correspondence between at least one set of input information and the CSI reporting information, for example, include a correspondence between multiple sets of different input information and the CSI reporting information.

In some embodiments, the above correspondence between the input information and the CSI reporting information may include at least one of the following examples 1 to 5.

### Example 1: a Correspondence Between a Rank Corresponding to at Least One Set of Input Information and a Data Volume of the CSI Reporting Information

In some embodiments, when the type of the input information is a feature vector, the first configuration information is configured to indicate a correspondence between a rank corresponding to at least one set of input information and the data volume of the CSI reporting information. For example, for different correspondences, the rank corresponding to the input information is different and thus the corresponding data volume of the CSI reporting information is also different.

In some embodiments, a number of the ranks corresponding to the input information is less than or equal to a number of ports of a reception antenna of the terminal device. For example, the number of the ranks corresponding to the input information is K, that is, the ranks corresponding to the input information include rank=1, 2, . . . , K, where K is a positive integer and less than or equal to the number of ports of the reception antenna of the terminal device.

In some embodiments, the data volume can be represented by any of the following values: a number of parameters, a bit number and a compression ratio. The number of parameters can be a number of parameters obtained by performing compression encoding on the input information through the CSI compression encoding model. The parameters may be in the form of one of or combination of several of floating point, integer, complex number or other values, which is not limited herein. The bit number is a bit number included in a bit stream obtained by quantization on parameters obtained by performing compression encoding on the input information through the CSI compression encoding model. The compression ratio is a ratio of the number of parameters obtained by performing compression encoding on the input information through the CSI compression encoding model to the number of parameters included in the input information.

Illustratively, when the type of the input information is a feature vector, the first configuration information may be one table or represented in the form of table. The contents of the table include a floating point number or bit number of the CSI reporting information corresponding to rank=1, 2, . . . , K respectively, and the floating point number or bit number can also be calculated based on a rank value-related formula. K is less than or equal to the number of ports of the reception antenna of the terminal device.

### Example 2: a Correspondence Between a Number of Frequency Domain Units Corresponding to at Least One Set of Input Information and the Data Volume of the CSI Reporting Information

In some embodiments, when the type of the input information is full channel information, the first configuration information is configured to indicate a correspondence between a number of frequency domain units corresponding to at least one set of input information and the data volume of the CSI reporting information. For example, for different correspondences, the number of frequency domain units corresponding to the input information is different and the corresponding data volume of the CSI reporting information is also different.

In some embodiments, the number of frequency domain units corresponding to the input information is less than or equal to a number of frequency domain units where the reference signal is located. Illustratively, the reference signal may be a CSI-RS. The network device transmits a CSI-RS to the terminal device and the terminal device receives the CSI-RS and obtains CSI by estimation. For example, the number of frequency domain units corresponding to the input information is L and L is a positive integer and less than or equal to the number of frequency domain units where the reference signal is located.

In some embodiments, the frequency domain units are Resource Block (RB), or sub-carrier or sub-band. Of course, another form of frequency domain units can also be used, which is not limited in the present disclosure.

For example, when the type of the input information is full channel information, the first configuration information may be one table or represented in the form of table. The contents of the table include a floating point number or bit number of the CSI reporting information corresponding to the number of frequency domain units=1, 2, . . . , L respectively, and the floating point number or bit number can also be calculated based on a formula related to the number of frequency domain units. L is less than or equal to the number of frequency domain units where the reference signal is located.

### Example 3: a Correspondence Between at Least One First Value Range and the Data Volume of the CSI Reporting Information, Where the First Value Range Refers to a Value Range of the Rank Corresponding to the Input Information

In some embodiments, when the type of the input information is a feature vector, the first configuration information is configured to indicate a correspondence between at least one first value range and the data volume of the CSI reporting information. The first value range refers to a value range of the rank corresponding to the input information. For example, for different correspondences, the first value range is different and the corresponding data volume of the CSI reporting information is also different.

For example, when the type of the input information is a feature vector, the first configuration information may be one table or represented in the form of table. The contents of the table include a floating point number or bit number of the CSI reporting information corresponding to the rank within a range, for example, include the corresponding floating point number or bit number at the time of rank<=2, and the corresponding floating point number or bit number at the time of 2<rank<=4.

### Example 4: a Correspondence Between at Least One Second Value Range and the Data Volume of the CSI Reporting Information, Where the Second Value Range Refers to a Value Range of the Number of the Frequency Domain Units Corresponding to the Input Information

In some embodiments, when the type of the input information is full channel information, the first configuration information is configured to indicate a correspondence between at least one second value range and the data volume of the CSI reporting information.

The second value range refers to a value range of the number of the frequency domain units corresponding to the input information. Illustratively, for different correspondences, the second value range is different and the corresponding data volume of the CSI reporting information is also different.

Illustratively, when the type of the input information is full channel information, the first configuration information may be one table or represented in the form of table. The contents of the table include a floating point number or bit number of the CSI reporting information corresponding to the number of frequency domain units within a range, for example, include the corresponding floating point number or bit number at the time of the number of frequency domain units<L/2, and the corresponding floating point number or bit number at the time of L/2 <=the number of frequency domain units<=L.

### Example 5: a Correspondence Between a Data Volume of at Least One Set of Input Information and the Data Volume of the CSI Reporting Information

Illustratively, when the type of input information is a feature vector or full channel information, the first configuration information may be one table or represented in the form of table. The contents of the table include at least one correspondence between a floating point number or bit number of the input information and the floating point number or bit number of the CSI reporting information. Illustratively, for different correspondences, the data volume of the input information is different and the corresponding data volume of the CSI reporting information is also different.

The above-mentioned full channel information refers to an angle domain-delay domain channel obtained by performing Inverse Discrete Fourier Transform (IDFT) on channel information containing space domain and frequency domain and obtained by the terminal device measuring a downlink reference signal. The feature vector refers to feature information extracted from the channel information containing space domain and frequency domain and obtained by the terminal device measuring a downlink reference signal. The feature information is represented in the form of one or more groups of vectors. Furthermore, the relationship of the number of parameters, the bit number and the compression ratio are below: by a quantization method, the parameters (e.g. parameters in any form of floating point number, or real number or complex number or the like) are quantized into one binary bit sequence (or called bit stream), where the number of the bits in the bit sequence is the bit number. For example, the quantization degree is 4, and each parameter can be quantized into two bits for representation. Further, based on the compression ratio and the input information (e.g. number of parameters included in the input information), the number of parameters or bit number obtained by performing compression encoding on the input information can be calculated.

In the technical solutions provided by the embodiments of the present disclosure, by configuring the correspondence between the input information of the CSI compression encoding model and the CSI reporting information, the terminal device can, when performing compression encoding on the CSI by the CSI compression encoding model, generate the CSI reporting information meeting the configuration requirement, which helps improve the success rate and accuracy of the network device in decoding and recovery of the CSI.

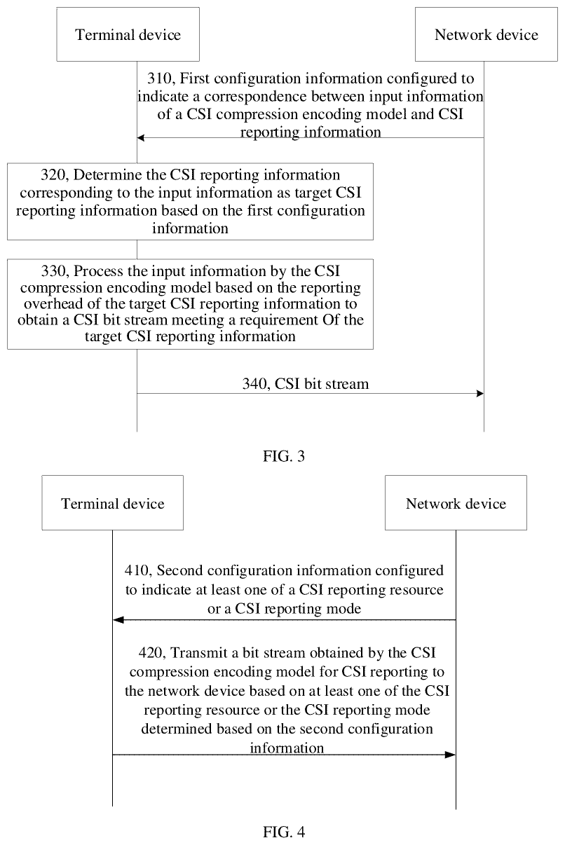

FIG. 3 is a flowchart illustrating a communication method according to another embodiment of the present disclosure. The embodiment is exemplified with the method being applied to the network architecture shown in FIG. 1. The method includes at least one of steps 310 to 340.

At step 310, the network device transmits first configuration information to the terminal device, where the first configuration information is configured to indicate a correspondence between input information of a channel state information (CSI) compression encoding model and CSI reporting information.

Correspondingly, the terminal device receives the first configuration information from the network device.

For those details not described in the step, reference can be made to the method embodiment shown in FIG. 2 and no redundant descriptions are made in the embodiment.

At step 320, the terminal device determines the CSI reporting information corresponding to the input information as target CSI reporting information based on the first configuration information.

The input information may be information obtained by performing reprocessing on the CSI obtained by the terminal device measuring a reference signal (e.g. CSI-RS) transmitted by the network device. The type of the input information may be full channel information, or a feature vector. After obtaining the input information, the terminal device can query the correspondence (or table) indicated by the first configuration information to determine the CSI reporting information corresponding to the input information as target CSI reporting information.

For example, when the first configuration information includes the floating point number or bit number of the CSI reporting information corresponding to rank=1, 2, . . . . K respectively, if the rank corresponding to the input information is rank=2, the terminal device can determine the floating point number or bit number of the CSI reporting information corresponding to the rank=2 as reporting overhead of the target CSI reporting information from the above correspondence (or table).

For example, when the first configuration information includes the floating point number or bit number of the CSI reporting information corresponding to the number of frequency domain units=1, 2, . . . . L respectively, if the number of frequency domain units corresponding to the input information is 3, the terminal device can determine the floating point number or bit number of the CSI reporting information corresponding to the number of frequency domain units=3 as reporting overhead of the target CSI reporting information from the above correspondence (or table).

For example, when the first configuration information includes the floating point number or bit number of the CSI reporting information corresponding to the rank within a range, for example, includes the corresponding floating point number or bit number at the time of rank<=2, and the corresponding floating point number or bit number at the time of 2<rank<=4, if the rank corresponding to the input information is rank=1, the terminal device can determine the floating point number or bit number of the CSI reporting information corresponding to rank<=2 as reporting overhead of the target CSI reporting information from the above correspondence (or table).

For example, when the first configuration information includes the floating point number or bit number of the CSI reporting information corresponding to the number of frequency domain units within a range, for example, includes the corresponding floating point number or bit number at the time of the number of frequency domain units<L/2, and the corresponding floating point number or bit number at the time of L/2<=the number of frequency domain units<=L, if the number of frequency domain units corresponding to the input information is =2 and L=8, the terminal device can determine the floating point number or bit number of the CSI reporting information corresponding to the number of frequency domain units <L/2 as reporting overhead of the target CSI reporting information from the above correspondence (or table).

For example, when the first configuration information includes at least one correspondence between the floating point number or bit number of the input information and the floating point number or bit number of the CSI reporting information, the terminal device can determine, based on the floating point number or bit number of the input information, the corresponding floating point number or bit number of the CSI reporting information as reporting overhead of the target CSI reporting information from the above correspondence (or table).

At step 330, the terminal device processes to-be-reported CSI by the CSI compression encoding model based on the reporting overhead of the target CSI reporting information to obtain a CSI bit stream meeting a requirement of the target CSI reporting information.

The target CSI reporting information stipulates or constrains a data volume of the CSI reported by the terminal device to the network device, such as a number of parameters, a bit number or a compression ratio. When processing the to-be-reported CSI by the CSI compression encoding model, the terminal device can generate a CSI bit stream meeting the above stipulation or constraint of the target CSI reporting information based on the above stipulation or constraint of the target CSI reporting information.

At step 340, the terminal device transmits the CSI bit stream to the network device.

After receiving the CSI bit stream from the terminal device, the network device can perform de-quantization on the CSI bit stream and then input information obtained by de-quantization into a CSI decoding model for decoding to obtain the recovered CSI. The CSI decoding model is an AI/ML model for CSI decoding.

In some embodiments, the network device can determine model parameters of the CSI decoding model based on the data volume (e.g. a number of parameters or a bit number) of the CSI bit stream received from the terminal device, and then decode the information obtained by de-quantization through the CSI decoding model to obtain the recovered CSI. In this way, the network device can successfully recover the CSI.

FIG. 4 is a flowchart illustrating a communication method according to another embodiment of the present disclosure. The embodiment is illustrated with the method being applied to the network architecture shown in FIG. 1. The method includes at least one step of the following steps 410 to 420.

At step 410, the network device transmits second configuration information to the terminal device, where the second configuration information is configured to indicate at least one of a CSI reporting resource or a CSI reporting mode.

Correspondingly, the terminal device receives the second configuration information from the network device.

The CSI reporting resource refers to a resource used by the terminal device to report CSI to the network device, for example, a time frequency resource and the like. The CSI reporting resource can also be referred to as CSI feedback resource or uplink feedback resource, which is not limited in the present disclosure. The CSI reporting mode refers to a mode in which the terminal device reports CSI to the network device, for example, 0-filling mode or split mode.

At step 420, the terminal device transmits a bit stream obtained by the CSI compression encoding model for CSI reporting to the network device based on at least one of the CSI reporting resource or the CSI reporting mode determined based on the second configuration information.

The bit stream for CSI reporting is also called CSI bit stream and accordingly, the network device receives the CSI bit stream from the terminal device. In addition, for the process of the terminal device for generating the CSI bit stream, refer to the descriptions in the embodiment shown in FIG. 3 and no redundant descriptions are made in the embodiment.

In some embodiments, the CSI reporting mode includes at least one of the following modes 1 to 2.
Mode 1: 0-filling mode which means that the network device configures a reporting resource required for a maximum bit number of the CSI bit stream and the terminal device fills 0 in the bits unoccupied by the CSI bit stream in the maximum bit number.

For example, the maximum bit number is 8 and the bit number actually occupied by the CSI bit stream is 4 and thus there are four unoccupied bits where 0 is filled.
Mode 2: split mode which means the CSI is split into a first part and a second part, the bit number of the first part is fixed or a required reporting resource is determined, and based on the contents of the first part, a bit number of the second part or a size of required reporting resource is determined.

In some embodiments, when the input information of the CSI compression encoding model is a feature vector, for the 0-filling mode, the maximum bit number is a product of a number of to-be-reported frequency domain units, a number of antenna ports of the network device, a number of antenna ports of the terminal device and a quantized bit number; for the split mode, the first part at least includes information for determining a rank value and the second part includes feature vector-related information output by the CSI compression encoding model and corresponding to the rank value.

Illustratively, when the input information of the CSI compression encoding model is a feature vector, the network device may, when configuring the CSI reporting resource, perform configuration based on one of the following mode A and mode B.
Mode A: it is the 0-filling mode. The network device configures a maximum feedback overhead (i.e. the above maximum bit number), where the maximum feedback overhead=the number of to-be-reported frequency domain units*the number of antenna ports of the network device*the number of antenna ports of the terminal device*the quantized bit number, the frequency domain units may be sub-band and*represents multiplication. The terminal device fills 0 for a difference between actual feedback overhead and maximum feedback overhead. The network device can also configure wideband feedback or partial sub-band feedback. At this time, the maximum feedback overhead is the number of antenna ports of the network device*the number of antenna ports of the terminal device*the quantized bit number or the number of partial frequency domain units*the number of antenna ports of the network device*the number of antenna ports of the terminal device*the quantized bit number; where the number of partial frequency domain units is a number of frequency domain units contained in the partial sub-band configured by the network device.
Mode B: it is the split mode. The CSI is split into two parts. The bit number of the first part is fixed and the contents of the second part can be determined based on the contents of the first part. For example, the rank value can be determined based on the contents of the first part. Therefore, the first part at least includes the rank value. The CSI of the first part does not preclude other information reporting affecting the CSI overhead of the second part. The second part at least includes feature vector-related information corresponding to the rank value and output by the CSI compression encoding model.

In some embodiments, when the input information of the CSI compression encoding model is full channel information, for the 0-filling mode, the maximum bit number is a product of a number of all frequency domain units, a number of antenna ports of the network device, a number of antenna ports of the terminal device and a quantized bit number: the number of all frequency domain units refers to frequency domain units within a frequency domain range where the reference signal (RS), for CSI reporting, measured by the terminal device is; for the split mode, the first part includes information for determining a number of valid frequency domain units and the second part includes full channel-related information corresponding to the number of valid frequency domain units and output by the CSI compression encoding model.

Illustratively, when the input information of the CSI compression encoding model is full channel information or angular-delay domain channel information (notes: the angular-delay domain channel information is one of full channel information), the network device can perform configuration based on one of the following modes C and D during configuration of the CSI reporting resource.
Mode C: it is the 0-filling mode. The network device configures a maximum feedback overhead (i.e. the above maximum bit number), and the maximum feedback overhead=the number of all frequency domain units*the number of antenna ports of the network device*the number of antenna ports of the terminal device*the quantized bit number. The terminal device fills 0 for the difference between the actual feedback overhead and the maximum feedback overhead.
Mode D: it is the split mode. The CSI is split into two parts, and the network device configures the reporting as two parts. The bit number of the first part is fixed and the bit number of the second part can be determined based on the contents of the first part. For example, the number of frequency domain units can be determined based on the contents of the first part. Therefore, the first part at least includes the number of valid frequency domain units. The CSI of the first part does not preclude other information reporting affecting the CSI overhead of the second part. The second part at least includes full channel-related information output by the CSI compression encoding model.

In some embodiments, that the terminal device performs reporting based on the 0-filling mode or the split mode depends on the network device. For example, the network device indicates the CSI reporting mode in the second configuration information and the terminal device determines to use the CSI reporting mode based on the second configuration information.

In some embodiments, for the above split mode, the configuration for the first part and the second part meets at least one of the followings:
configuring different time domain reporting characteristics;
configuring different frequency domain reporting characteristics: or
configuring different physical channels.

Illustratively, the time domain reporting characteristics include at least one of: periodic reporting, semistatic reporting and non-periodic reporting. For example, the first part uses the periodic or semistatic reporting and the second part uses semistatic or non-periodic reporting.

Illustratively, the frequency domain reporting characteristics include at least one of: wideband reporting and sub-band reporting. For example, the first part uses the wideband reporting and the second part uses the wideband or sub-band reporting.

Illustratively, the physical channels include at least one of: Physical Uplink Control Channel (PUCCH) and Physical Uplink Shared Channel (PUSCH). For example, the first part uses PUCCH for reporting and the second part uses PUCCH or PUSCH for reporting.

It should be noted that the time domain reporting characteristics of the first part and the second part may be same or different; the frequency domain reporting characteristics of the first part and the second part may be same or different; the physical channels of the first part and the second part may be same or different. That is, the first part and the second part are not compulsorily different in time domain reporting characteristics, frequency domain reporting characteristics and physical channel but can be configured with different characteristics. For example, the first part uses semistatic wideband reporting on the PUCCH and the second part uses the non-periodic wideband reporting on the PUSCH.

In some embodiments, for the split mode, if the contents included in the second part are to be discarded due to shortage of the CSI reporting resource, for different contents of a same repeat transmission in the second part, the descending discarding priority is wideband CSI, even sub-band CSI and odd sub-band CSI; for the contents of different repeat transmissions in the second part, the discarding priority is: the contents of the i-th repeat transmission and the contents of higher than the (i+1)-th repeat transmission, where i is a positive integer.

For example, the descending discarding priority is:
1. Part 2 wideband CSI for rep-1 (the wideband CSI of the second part of the first repeat transmission);
2. Part 2 subband CSI of even subband for rep-1 (the even sub-band CSI of the second part of the first repeat transmission);
3. Part 2 subband CSI of odd subband for rep-1 (the odd sub-band CSI of the second part of the first repeat transmission);
4. Part 2 wideband CSI for rep-2 (the wideband CSI of the second part of the second repeat transmission);
5. Part 2 subband CSI of even subband for rep-2 (the even sub-band CSI of the second part of the second repeat transmission);
6. Part 2 subband CSI of odd subband for rep-2 (the odd sub-band CSI of the second part of the second repeat transmission);
. . .

where rep-x represents a number of repeat transmissions. For example, rep-1 represents one repeat transmission and thus the CSI reporting is transmitted only once. At this time, only the priority shown in the above 1 to 3 is taken into account. For example, rep-2 represents two repeat transmissions and thus the CSI reporting is transmitted twice. At this time, the priority shown in the above 1 to 6 is taken into account. Of course, there may be rep-3, rep-4 and the like, and the discarding priority can be inferred by analogy and no redundant descriptions are made herein.

In the technical solutions provided by the embodiments of the present disclosure, the network device configures a CSI reporting resource and/or a CSI reporting mode for the terminal device, and the terminal device can perform CSI reporting to the network device based on the configuration of the network device, helping improve the success rate and accuracy of the network device in decoding and recovery of the CSI. Furthermore, the network device can configure different CSI reporting resources and/or CSI reporting modes based on different situations to avoid the waste of the CSI reporting resources with consideration on the accuracy and the resource utilization rate of the CSI recovery.

It should be noted that the above steps performed by the terminal device can be separately implemented as the communication method of the terminal device side; the above steps performed by the network device can be separately implemented as the communication method of the network device side.

Below are apparatus embodiments of the present disclosure, which are configured to implement the method embodiments of the present disclosure. Those details not mentioned in the apparatus embodiments of the present disclosure can be seen in the method embodiments of the present disclosure.

Below are apparatus embodiments of the present disclosure, which are configured to implement the method embodiments of the present disclosure. Those details not mentioned in the apparatus embodiments of the present disclosure can be seen in the method embodiments of the present disclosure.

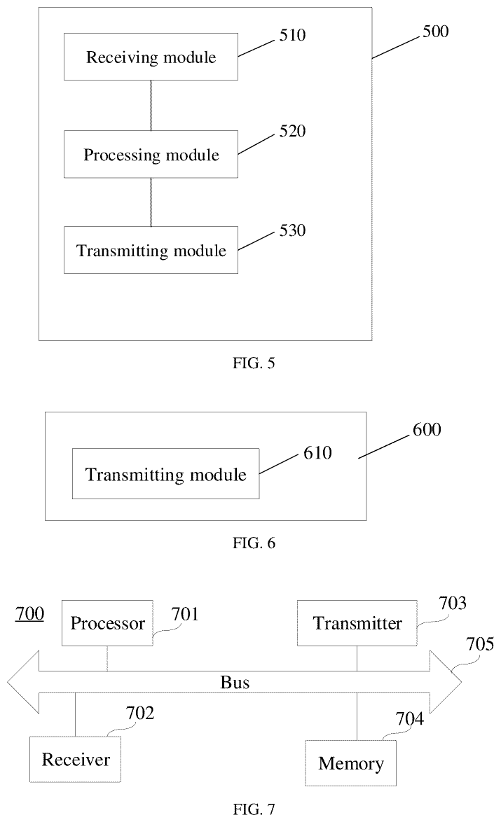

FIG. 5 is a block diagram illustrating a communication apparatus according to an embodiment of the present disclosure. The apparatus has the function to implement the method example of the terminal device side. The function can be implemented by hardware, or by running software through hardware. The apparatus may be the above terminal device, or provided in the terminal device. As shown in FIG. 5, the apparatus 500 may include a receiving module 510.

The receiving module 510 is configured to receive first configuration information from a network device, where the first configuration information is configured to indicate a correspondence between input information of a Channel State Information (CSI) compression encoding model and CSI reporting information.

In some embodiments, the correspondence between the input information and the CSI reporting information may include at least one of:
a correspondence between a rank corresponding to at least one set of input information and a data volume of the CSI reporting information;
a correspondence between a number of frequency domain units corresponding to at least set of input information and the data volume of the CSI reporting information;
a correspondence between at least one first value range and the data volume of the CSI reporting information, where the first value range refers to a value range of the rank corresponding to the input information;
a correspondence between at least one second value range and the data volume of the CSI reporting information, where the second value range refers to a value range of the number of the frequency domain units corresponding to the input information; or
a correspondence between a data volume of at least one set of input information and the data volume of the CSI reporting information.

In some embodiments, a number of ranks corresponding to the input information is less than or equal to a number of ports of a reception antenna of the terminal device.

In some embodiments, the number of the frequency domain units corresponding to the input information is less than or equal to a number of frequency domain units where a reference signal is located.

In some embodiments, the frequency domain units are resource block (RB) or sub-carrier or sub-band.

In some embodiments, the data volume is represented by any value of the followings: a number of parameters, a bit number and a compression ratio.

In some embodiments, as shown in FIG. 5, the apparatus 500 further includes a processing module 520, which is configured to determine, based on the first configuration information, CSI reporting information corresponding to the input information as target CSI reporting information; process the input information by a CSI compression encoding model based on the target CSI reporting information to obtain a CSI bit stream meeting the requirement of target CSI reporting information.

In some embodiments, as shown in FIG. 6, the apparatus 500 further includes a transmitting module 530.

The receiving module 530 is further configured to receive second configuration information from the network device, where the second configuration information is configured to indicate a CSI reporting resource and/or a CSI reporting mode.

The transmitting module 530 is configured to, based on the CSI reporting resource and/or the CSI reporting mode determined based on the second configuration information, transmit a bit stream obtained by the CSI compression encoding model for CSI reporting to the network device.

In some embodiments, the CSI reporting mode includes at least one of:
a 0-filling mode which refers to that the network device configures a reporting resource required by a maximum bit number of the CSI bit stream and the terminal device fills 0 in the bits unoccupied by the CSI bit stream in the maximum bit number; or
a split mode which refers to that the CSI is split into a first part and a second part, the bit number of the first part is fixed or required reporting resource is determined, and based on the contents of the first part, a bit number of the second part or a size of required reporting resource is determined.

In some embodiments, when the input information of the CSI compression encoding model is a feature vector,
for the 0-filling mode, the maximum bit number is a product of a number of to-be-reported frequency domain units, a number of antenna ports of the network device, a number of antenna ports of the terminal device, and a quantized bit number;
for the split mode, the first part at least includes information for determining a rank value, and the second part includes feature vector-related information corresponding to the rank value and output by the CSI compression encoding model.

In some embodiments, when the input information of the CSI compression encoding model is full channel information,
for the 0-filling mode, the maximum bit number is a product of a number of all frequency domain units, a number of antenna ports of the network device, a number of antenna ports of the terminal device and a quantized bit number; the number of all frequency domain units refers to frequency domain units within a frequency domain range where the reference signal (RS), for CSI reporting, measured by the terminal device is;
for the split mode, the first part includes information for determining a number of valid frequency domain units and the second part includes full channel-related information corresponding to the number of valid frequency domain units and output by the CSI compression encoding model.

In some embodiments, the configuration for the first part and the second part meets at least one of:
configuring different time domain reporting characteristics;
configuring different frequency domain reporting characteristics; or
configuring different physical channels.

In some embodiments, for the split mode, if the contents included in the second part are to be discarded due to shortage of the CSI reporting resource, for different contents of a same repeat transmission in the second part, a descending discarding priority is wideband CSI, even sub-band CSI and odd sub-band CSI; for the contents of different repeat transmissions in the second part, the discarding priority is the contents of the i-th repeat transmission, and the contents of higher than the (i+1)-th repeat transmission, where i is a positive integer.

FIG. 6 is a block diagram illustrating a communication apparatus according to an embodiment of the present disclosure. The apparatus has the function to implement the method example of the above network device side. The function can be implemented by hardware or by running software through hardware. The apparatus may be the above network device or provided in the network device. As shown in FIG. 6, the apparatus 600 may include a transmitting module 610.

The transmitting module 610 is configured to transmit first configuration information to a terminal device, where the first configuration information is configured to indicate a correspondence between input information of a Channel State Information (CSI) compression encoding model and CSI reporting information.

In some embodiments, the correspondence between the input information and output information includes at least one of:
a correspondence between a rank corresponding to at least one set of input information and a data volume of the CSI reporting information;
a correspondence between a number of frequency domain units corresponding to at least set of input information and the data volume of the CSI reporting information;
a correspondence between at least one first value range and the data volume of the CSI reporting information, where the first value range refers to a value range of the rank corresponding to the input information;
a correspondence between at least one second value range and the data volume of the CSI reporting information, where the second value range refers to a value range of the number of the frequency domain units corresponding to the input information; or
a correspondence between a data volume of at least one set of input information and the data volume of the CSI reporting information.

In some embodiments, a number of ranks corresponding to the input information is less than or equal to a number of ports of a reception antenna of the terminal device.

In some embodiments, the number of the frequency domain units corresponding to the input information is less than or equal to a number of frequency domain units where a reference signal is located.

In some embodiments, the frequency domain units are resource block (RB) or sub-carrier or sub-band.

In some embodiments, the data volume is represented by any value of the followings: a number of parameters, a bit number and a compression ratio.

In some embodiments, the transmitting module 610 is further configured to transmit second configuration information to the terminal device, where the second configuration information is configured to indicate a CSI reporting resource and/or a CSI reporting mode.

In some embodiments, the CSI reporting mode includes at least one of:
a 0-filling mode which refers to that the network device configures a reporting resource required by a maximum bit number of a CSI bit stream and the terminal device fills 0 in the bits unoccupied by the CSI bit stream in the maximum bit number; or
a split mode which refers to that the CSI is split into a first part and a second part, the bit number of the first part is fixed or a required reporting resource is determined, and based on the contents of the first part, a bit number of the second part or a size of required reporting resource is determined.

In some embodiments, when the input information of the CSI compression encoding model is a feature vector,
for the 0-filling mode, the maximum bit number is a product of a number of to-be-reported frequency domain units, a number of antenna ports of the network device, a number of antenna ports of the terminal device, and a quantized bit number;
for the split mode, the first part at least includes information for determining a rank value, and the second part includes feature vector-related information corresponding to the rank value and output by the CSI compression encoding model.

In some embodiments, when the input information of the CSI compression encoding model is full channel information, for the 0-filling mode, the maximum bit number is a product of a number of all frequency domain units, a number of antenna ports of the network device, a number of antenna ports of the terminal device and a quantized bit number; the number of all frequency domain units refers to frequency domain units within a frequency domain range where the reference signal (RS), for CSI reporting, measured by the terminal device is; for the split mode, the first part includes information for determining a number of valid frequency domain units and the second part includes full channel-related information corresponding to the number of valid frequency domain units and output by the CSI compression encoding model.

In some embodiments, the configuration for the first part and the second part meets at least one of:
configuring different time domain reporting characteristics;
configuring different frequency domain reporting characteristics; or
configuring different physical channels.

In some embodiments, for the split mode, if the contents included in the second part are to be discarded due to shortage of the CSI reporting resource, for different contents of a same repeat transmission in the second part, a descending discarding priority is wideband CSI, even sub-band CSI and odd sub-band CSI; for the contents of different repeat transmissions in the second part, the discarding priority is the contents of the i-th repeat transmission, and the contents of higher than the (i+1)-th repeat transmission, where i is a positive integer.

It should be noted that the apparatus provided by the above embodiments is exemplified with division of the above functional modules during the implementation of its functions. In practical applications, the above functions are allocated to different functional modules for execution based on actual requirements, that is, the content structure of the device is divided into different functional modules to complete all or part of the functions mentioned above.

The specific manners in which each module of the apparatus in the above embodiments performs operation have been detailed in the above method embodiments and will not be described redundantly. Those details not mentioned in the apparatus embodiments can be seen in the above method embodiments.

FIG. 7 is a block diagram illustrating a communication device 700 according to an embodiment of the present disclosure. The communication device 700 may be the above terminal device or network device. The communication device 700 may include: a processor 701, a receiver 702, a transmitter 703, a memory 704 and a bus 705. The processor 701 can be configured to implement the functions of the processing module in the above apparatus embodiments and the receiver 702 can be configured to implement the functions of the receiving module in the above apparatus embodiments, and the transmitter 703 can be configured to implement the functions of the transmitting module in the above apparatus embodiments.

The processor 701 includes one or more processing cores and the processor 701 executes various functional applications and information processing by running software programs and modules.

The receiver 702 and transmitter 703 can be implemented as one communication component which can be one communication chip.

The memory 704 is connected with the processor 701 via the bus 705.

The memory 704 can be configured to store computer programs and the processor 701 can be configured to execute the computer programs to implement the communication method of the terminal device side or the communication method of the network device side.

Furthermore, the memory 704 may be implemented by any type of volatile or non-volatile storage devices or a combination thereof. The volatile or non-volatile storage devices include but not limited to a magnetic disk, a compact disk, an Electrically Erasable Programmable Read-Only Memory (EEPROM), an Erasable Programmable Read-Only Memory (EPROM), a Static Random Access Memory (SRAM), a Read-Only Memory (ROM), a magnetic memory, a flash memory, and a Programmable Read-Only Memory (PROM).

An embodiment of the present disclosure further provides a computer readable storage medium, storing computer programs. The computer programs are executed by a processor to perform the communication method of the terminal device side or the communication method of the network device side. Optionally, the computer readable storage medium may include: a Read-Only Memory (ROM), a Random-Access Memory (RAM), Solid State Drives (SSD), or compact disk or the like. The random access memory may include: a Resistance Random Access Memory (ReRAM), and Dynamic Random Access Memory (DRAM).

An embodiment of the present disclosure provides a communication system which includes a terminal device and a network device. The terminal device is configured to perform the communication method of the terminal device side and the network device is configured to perform the communication method of the network device side.

An embodiment of the present disclosure further provides a chip, which includes a programmable logic circuit and/or program instructions. The chip runs to perform the communication method of the terminal device side or the communication method of the network device side.

An embodiment of the present disclosure further provides a computer program product which includes computer instructions. The computer instructions are stored in a computer readable storage medium. A processor reads and executes the computer instructions from the computer readable storage medium to perform the communication method of the terminal device side or the communication method of the network device side.

By configuring the correspondence between the input information of the CSI compression encoding model and the CSI reporting information, the terminal device can, when performing compression encoding on the CSI by the CSI compression encoding model, generate the CSI reporting information meeting the configuration requirement, helping improve the success rate and accuracy of the network device in decoding and recovery of the CSI.

It should be understood that the “indication” mentioned in the embodiments of the present disclosure may be direct indication or indirect indication and can also represent having an association relationship. For example, A indicates B, which means A directly indicates B, for example, B can be obtained by A; or means A indirectly indicates B, for example, A indicates C and B can be obtained by C; or means there is an association relationship between A and B.

In the descriptions of the embodiments of the present disclosure, the term “correspondence” can represent a direct correspondence or indirect correspondence between both, or an association relationship between both, or a relationship of indicating and being indicated, and configuring and being configured and the like.

In some embodiments of the present disclosure, the “predefined” can be implemented by pre-storing corresponding codes, forms or another way for indicating relevant information in the device (e.g. including the terminal device and the network device), and the specific implementation is not limited in the present disclosure. For example, the “predefined” may be predefined in protocol.

In some embodiments of the present disclosure, the “protocol” may refer to a standard protocol in the communication field, for example, may include an LTE protocol, an NR protocol, and a relevant protocol applied to future communication system, which is not limited in the present disclosure.

The term “multiple” referred to in the present disclosure refers to two or more. The term “and/or” is configured to describe an association relationship of associated objects, which includes three relationships. For example, A and/or B may refer to that A is present alone, A and B are present at the same time, and B is present alone. The character “/” generally refers to an “or” relationship of the objects associated back and forth.

The term “greater than or equal to” mentioned in the present disclosure refers to greater than and equal to or greater than, and the term “less than or equal to” refers to less than and equal to or less than.

Furthermore, the step numerals described in the present disclosure are used only to exemplify one possible execution sequence. In some other embodiments, the above steps may also be executed in a sequence different from the numerals, for example, two steps with different numerals can be performed at the same time or performed in a sequence contrary to the sequence shown, which is not limited in the embodiments of the present disclosure.

Moreover, the embodiments provided by the present disclosure can be arbitrarily combined to form new embodiments which all fall within the scope of protection of the present disclosure.

Those skilled in the art should be aware that in one or more examples, the functions described in the embodiments of the present disclosure can be implemented by hardware, software, firmware or combination thereof. When the functions are implemented by software, these functions can be stored in a computer readable storage medium or transmitted as one or more instructions or codes on the computer readable storage medium. The computer readable medium includes a computer storage medium and a communication medium. The communication medium includes any medium for facilitating transmission of computer programs from one place to another. The storage medium may be any medium accessible to a general or dedicated computer.

The above are only example embodiments of the present disclosure and shall not be configured to limit the present disclosure. Any modifications, equivalent substitutions and improvements and the like made within the spirit and principle of the present disclosure shall fall within the scope of protection of the present disclosure.

1. A communication method, performed by a terminal device and comprising:
receiving first configuration information from a network device, wherein the first configuration information is configured to indicate a correspondence between input information of a channel state information (CSI) compression encoding model and CSI reporting information.

2. The method of claim 1, wherein the correspondence between the input information and the CSI reporting information comprises at least one of:
a correspondence between a rank corresponding to at least one set of input information and a data volume of the CSI reporting information;
a correspondence between a number of frequency domain units corresponding to at least set of input information and the data volume of the CSI reporting information;
a correspondence between at least one first value range and the data volume of the CSI reporting information, wherein the first value range refers to a value range of the rank corresponding to the input information;
a correspondence between at least one second value range and the data volume of the CSI reporting information, wherein the second value range refers to a value range of the number of the frequency domain units corresponding to the input information; or
a correspondence between a data volume of at least one set of input information and the data volume of the CSI reporting information.

3. The method of claim 2, wherein a number of ranks corresponding to the input information is less than or equal to a number of ports of a reception antenna of the terminal device.

4. The method of claim 2, wherein the number of the frequency domain units corresponding to the input information is less than or equal to a number of frequency domain units where a reference signal is located.

5. The method of claim 2, wherein the frequency domain units are resource blocks (RBs) or sub-carriers or sub-bands.

6. The method of claim 2, wherein the data volume is represented by any value of: a number of parameters, a bit number and a compression ratio.

7. The method of claim 1, further comprising:
determining, based on the first configuration information, the CSI reporting information corresponding to the input information as target CSI reporting information; and
processing, based on the target CSI reporting information, the input information by the CSI compression encoding model to obtain a CSI bit stream meeting a requirement of the target CSI reporting information.

8. The method of claim 1, further comprising:
receiving second configuration information from the network device, wherein the second configuration information is configured to indicate at least one of a CSI reporting resource or a CSI reporting mode; and
transmitting, by using at least one of the CSI reporting resource or the CSI reporting mode determined based on the second configuration information, to the network device the bit stream obtained by the CSI compression encoding model for CSI reporting.

9. The method of claim 8, wherein the CSI reporting mode comprises at least one of:
a 0-filling mode which refers to that the network device configures a reporting resource required by a maximum bit number of the CSI bit stream and the terminal device fills 0 in the bits unoccupied by the CSI bit stream in the maximum bit number; or
a split mode which refers to that the CSI is split into a first part and a second part, a bit number of the first part is fixed or a required reporting resource is determined, and a bit number of the second part or a size of the required reporting resource is determined based on contents of the first part.

10. The method of claim 9, wherein in a case that the input information of the CSI compression encoding model is a feature vector,
for the 0-filling mode, the maximum bit number is a product of a number of to-be-reported frequency domain units, a number of antenna ports of the network device, a number of antenna ports of the terminal device, and a quantized bit number;
for the split mode, the first part at least comprises information for determining a rank value, and the second part comprises feature vector-related information corresponding to the rank value and output by the CSI compression encoding model.

11. The method of claim 9, wherein in a case that the input information of the CSI compression encoding model is full channel information,
for the 0-filling mode, the maximum bit number is a product of a number of all frequency domain units, a number of antenna ports of the network device, a number of antenna ports of the terminal device and a quantized bit number; the number of all frequency domain units refers to frequency domain units within a frequency domain range where the reference signal (RS), for CSI reporting, measured by the terminal device is;
for the split mode, the first part comprises information for determining a number of valid frequency domain units and the second part comprises full channel-related information corresponding to the number of valid frequency domain units and output by the CSI compression encoding model.

12. The method of claim 9, wherein configuration for the first part and the second part meets at least one of:
configuring different time domain reporting characteristics;
configuring different frequency domain reporting characteristics; or configuring different physical channels.

13. The method of claim 9, wherein for the split mode, in response to contents comprised in the second part being to be discarded due to shortage of the CSI reporting resource, for different contents of a same repeat transmission in the second part, a descending discarding priority is wideband CSI, even sub-band CSI and odd sub-band CSI;
for contents of different repeat transmissions in the second part, the discarding priority is contents for the i-th repeat transmission, and contents for higher than the (i+1)-th repeat transmission, wherein i is a positive integer.

14. A communication method, performed by a network device and comprising:
transmitting first configuration information to a terminal device, wherein the first configuration information is configured to indicate a correspondence between input information of a channel state information (CSI) compression encoding model and CSI reporting information.

15. The method of claim 14, wherein the correspondence between the input information and output information comprises at least one of:
a correspondence between a rank corresponding to at least one set of input information and a data volume of the CSI reporting information;
a correspondence between a number of frequency domain units corresponding to at least set of input information and the data volume of the CSI reporting information;
a correspondence between at least one first value range and the data volume of the CSI reporting information, wherein the first value range refers to a value range of the rank corresponding to the input information;
a correspondence between at least one second value range and the data volume of the CSI reporting information, wherein the second value range refers to a value range of the number of the frequency domain units corresponding to the input information; or
a correspondence between a data volume of at least one set of input information and the data volume of the CSI reporting information.

16.-19. (canceled)

20. The method of claim 14, further comprising:
transmitting second configuration information to the terminal device, wherein the second configuration information is configured to indicate at least one of a CSI reporting resource or a CSI reporting mode.

21. The method of claim 20, wherein the CSI reporting mode comprises at least one of:
a 0-filling mode which refers to that the network device configures a reporting resource required by a maximum bit number of a CSI bit stream and the terminal device fills 0 in the bits unoccupied by the CSI bit stream in the maximum bit number; or
a split mode which refers to that the CSI is split into a first part and a second part, a bit number of the first part is fixed or a required reporting resource is determined, and a bit number of the second part or a size of the required reporting resource is determined based on contents of the first part.

22.-24. (canceled)

25. The method of claim 21, wherein for the split mode, in response to contents comprised in the second part being to be discarded due to shortage of the CSI reporting resource,
for different contents of a same repeat transmission in the second part, a descending discarding priority is wideband CSI, even sub-band CSI and odd sub-band CSI;
for contents of different repeat transmissions in the second part, the discarding priority is contents for the i-th repeat transmission, and contents for higher than the (i+1)-th repeat transmission, wherein i is a positive integer.

26. (canceled)

27. (canceled)

28. A terminal device, comprising:
a processor; and
a memory storing computer programs by the processor,
wherein the processor is configured to:
receive first configuration information from a network device, wherein the first configuration information is configured to indicate a correspondence between input information of a channel state information (CSI) compression encoding model and CSI reporting information.

29. A network device, comprising:
a processor; and
a memory storing computer programs by the processor,
wherein the processor is configured to perform the method of claims 14.

30.-32. (canceled)
